(19) United States
(12) Patent Application Publication
(10) Pub. No.: US 2013/0229276 A1
(43) Pub. Date: Sep. 5, 2013

(54) Systems and Methods for Providing Hand Washing and Sanitizing Alerts

(71) Applicant: Desiree Hunter, Charleston, SC (US)

(72) Inventor: Desiree Hunter, Charleston, SC (US)

(21) Appl. No.: 13/599,719

(22) Filed: Aug. 30, 2012

Related U.S. Application Data
(60) Provisional application No. 61/606,099, filed on Mar. 2, 2012.

(51) Int. Cl. G08B 21/22

(52) U.S. Cl. 340/501

(57) ABSTRACT

Embodiments of the disclosure can include systems, methods, and apparatus for providing hand washing and sanitizing alerts. Certain embodiments of the disclosure can improve hand hygiene by pairing an alert with the action of cleansing. In one embodiment, a method for providing hand washing and sanitizing alerts can be provided. The method can include generating an alert based at least in part on detecting a person entering or exiting an area. The method can further include ceasing the alert based at least in part on detecting the person sanitizing his or her hands.

### RELATED APPLICATION

The disclosure claims priority to U.S. Ser. No. 61/606,099, titled “Systems and Methods for Providing a Hand Washing and Sanitizing Alert System,” filed on Mar. 2, 2012, the contents of which are incorporated by reference.

### FIELD OF THE DISCLOSURE

The disclosure generally relates to healthcare, and more particularly, relates to systems, methods, and apparatus for providing hand washing and sanitizing alerts.

### BACKGROUND

The hands of health care workers, hospital beds and patients serve as homes to countless bacteria which lead to about 1.7 million infections and about 99,000 deaths per year, totaling about US$6.5 billion in health care costs. Many studies have shown a relationship between improved hand hygiene and decreased rates of transmissible infection. However, despite this strong evidence, certain hospital wards consistently report less than about 50% compliance with hand hygiene. Needless to say, change is needed, both for patient safety and to decrease total health care costs.

### SUMMARY OF THE DISCLOSURE

Embodiments of the disclosure can include systems, methods, and apparatus for providing hand washing and sanitizing alerts. Certain embodiments of the disclosure can improve hand hygiene by pairing an alert with the action of cleansing.

In one embodiment, a method for providing hand washing and sanitizing alerts can be provided. The method can include generating an alert based at least in part on detecting a person entering or exiting an area. The method can further include ceasing the alert based at least in part on detecting the person washing or sanitizing his or her hands.

In another embodiment, a system for providing hand washing and sanitizing alerts can be provided. The system can include at least one sanitizer device; at least one sensor; at least one alert device; and at least one processor operable to execute computer-executable instructions stored in a memory device. The instructions can be operable to, based at least in part on detecting, via the at least one sensor, a person entering or exiting an area, generate an alert; and based at least in part on detecting, via the at least one sanitizer device, the person washing or sanitizing his or her hands, cease the alert.

In yet another embodiment, one or more computer readable media for providing hand washing and sanitizing alerts can be provided. The one or more computer readable media can include computer-executable instructions stored in a memory for execution by at least one processor. The instructions can be operable to based at least in part on detecting, via at least one sensor, a person entering or exiting an area, generate an alert; and based at least in part on detecting, via at least one sanitizer device, the person washing or sanitizing his or her hands, cease the alert.

### BRIEF DESCRIPTION OF THE FIGURES

FIG. 1 illustrates an example system according to an embodiment of the disclosure.

FIG. 2 illustrates an example apparatus according to an embodiment of the disclosure.

FIG. 3 illustrates an example method according to an embodiment of the disclosure.

### DETAILED DESCRIPTION OF CERTAIN EMBODIMENTS OF THE DISCLOSURE

Embodiments of the disclosure can include systems, methods, and apparatus for providing hand washing and sanitizing alerts. Certain embodiments of the disclosure can improve hand hygiene by pairing an alert with the action of cleansing. Certain embodiments of the disclosure can be implemented in health care environments, food service environments, school environments, and other environments that monitor and/or depend on hand hygiene.

In one example embodiment, a system for providing hand washing and sanitizing alerts can be provided. In this example, a motion detector can be paired with a sanitizing device for a particular room or area. The motion detector can generate an alert that is triggered by any motion detected within the room or area. The motion detector can be installed in or adjacent to the room or area, for instance, at or adjacent to an entrance to the room or area. The sanitizing device can be a hand washing or hand sanitizing device, which may be selected depending on the suitability for a particular patient, area, room, or circumstance. In any instance, the motion detector can trigger the sanitizing device. Once triggered, the motion detector can set off any number or combinations of tactile alerts, such as a sound, a visual cue and/or a light near or on the sanitizing device that can serve as a reminder to a person to wash or sanitize his or her hands. The one or more alerts can be turned off when the sanitizing device is activated by the user.

In certain embodiments, an override device can be provided to turn off the one or more alerts, such as in case of accidental or inadvertent activation or an emergency. For example, an override device can be a prominently displayed button located on a patient's bedside controller or a motion detector located within the area or room, such as located adjacent to a patient.

Certain embodiments of the invention can provide a technical effect of active and/or passive alerts that may require active hand cleansing and/or washing in order to silence the alerts. In some instances, activation of a sanitizing device will be a path of least resistance for deactivating one or more alerts. In other instances, a reminder can be provided to persons entering or exiting certain areas or rooms, the persons can be held accountable to those already present, such as one or more patients, by alerting those present that sanitizing needs to be performed and deactivating the alerts when has been completed.

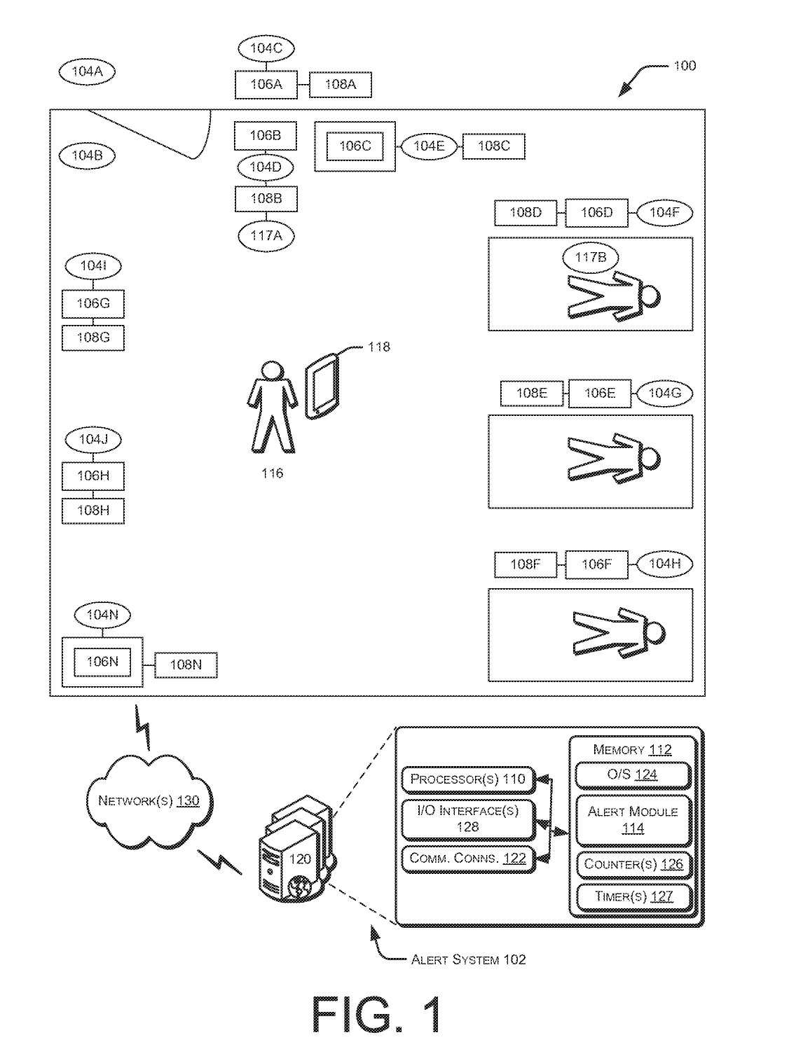

FIG. 1 illustrates an example environment and system according to an embodiment of the disclosure. The example environment can be a healthcare facility 100, and the system can be a hand washing and sanitizing alert system 102. The hand washing and sanitizing alert system 102 can include one or more sensors 104A-104N, one or more hand sanitizing devices 106A-106N, and one or more tactile alert devices 108A-108N. The system 102 can also include a controller, such as one or more processors 110, or similar control device operable to execute one or more computer-executable instructions stored in an associated memory, such as 112. The one or more processors can be in communication with the one or more sensors 104A-104N, one or more hand sanitizing devices 106A-106N, and one or more tactile alert devices 108A-108N. The computer-executable instructions can include an alert module 114, which can be operable to generate an alert based at least in part on detecting, via at least one sensor, a person entering or exiting an area, such as the healthcare facility. The alert module 114 can be further operable to cease the alert based at least in part on detecting, via at least one sanitizer device, the person washing or sanitizing his or her hands.

In the embodiment shown in FIG. 1, the one or more sensors 104A-104N can include, for example, at least one motion detection device. The one or more sensors 104A-104N, can also can include, for example, any combination of motion detection devices, motion sensors, face detectors, identification device readers, and/or thermal sensors. In certain embodiments, the one or more sensors 104A-104N can be positioned adjacent to an ingress or egress to the environment or healthcare facility 100, such as sensors 104A and 104B, or to any other area to be monitored. Further, one or more sensors, such as 104C-104N, can be positioned near or otherwise integrated with one or more hand sanitizing devices 106A-106N, wherein the operation of the hand sanitizing device can be detected by the corresponding or associated sensor. One will recognize that the one or more sensors 104A-104N can be positioned within or adjacent to the environment or healthcare facility 100, depending on the nature of the one or more sensors used. For example, an identification device reader, such as a biometric data, RFID detection device, or identification reader can be positioned outside, inside, or near an ingress or egress to the healthcare facility 100.

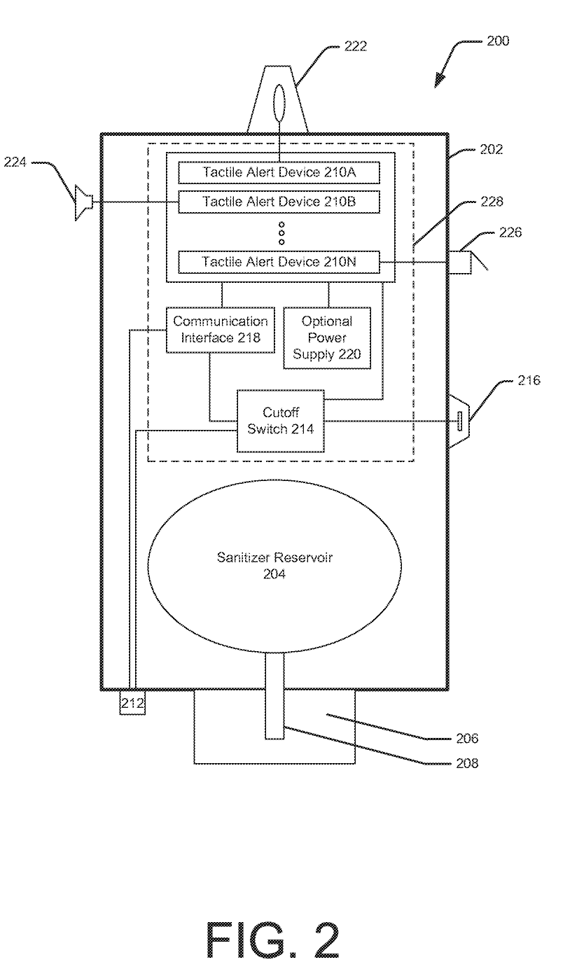

In the embodiment shown in FIG. 1, the one or more hand sanitizing devices 106A-106N can include, for example, at least one hand sanitizing gel dispenser device, such as described in FIG. 2. The one or more hand sanitizing devices 106A-106N can also include, for example, any combination of hand sanitizing devices, hand sanitizing gel dispenser devices, soap dispenser devices, plasma hand sanitizers, motion activated or touchless faucets, conventional faucets, sinks, and any other hand cleaning or sanitizing device. In certain embodiments, the one or more hand sanitizing devices, such as 106B, can be positioned near or within the environment or healthcare facility 100, either near an ingress or egress to the environment or healthcare facility 100, or in other locations as needed or convenient. In some instances, one or more hand sanitizing devices, such as 106C and 106N, can be positioned near sources of power, water, or other utilities as needed to facilitate suitable operation of the one or more hand sanitizing devices 106A-106N.

The embodiment of FIG. 1 can also include one or more tactile alert devices 108A-108N, which can include, for example, a light mounted near the one or more hand sanitizing devices 106A-106N. The one or more tactile alert devices 108A-108N can also include, for example, any combination of sound generators, lights, vibrating devices, and any other tactile generation devices. In certain embodiments, the one or more tactile alert devices, such as 108B-108C and 108G-108N, can be positioned near or within the environment or healthcare facility 100 adjacent to or mounted on the one or more hand sanitizing devices 106A-106N. In some instances, one or more tactile alert devices, such as 108D-108F, can be positioned within the environment or healthcare facility 100 adjacent to fixtures or patients that may be located within the environment or healthcare facility 100. For example, one or more tactile alert devices 108D-108F, such as lights, can be mounted to respective beds located within the environment or healthcare facility 100. By way of another example, one or more tactile alert devices 108D-108F, such as lights, can be mounted adjacent to respective bedside tables within the environment or healthcare facility 100. By way of further example, one or more tactile alert devices 108A-108N, such as a series of red and green lights, can be mounted to badges or wristbands worn by respective patients within the environment or healthcare facility 100.

In the embodiment of FIG. 1, a controller, such as processor 110, or similar control device can execute one or more computer-executable instructions associated with the alert module 114. The alert module 114, in this embodiment, can monitor the one or more sensors 104A-104N, such as a motion detector mounted adjacent to an ingress or egress to the environment or healthcare facility 100, for the approach and/or entry of a person, such as 116, into the monitored environment or healthcare facility 100. Upon detection of the person 116 by the at least one sensor, such as 104A or 104B, the alert module 114 can receive at least one signal or indication generated by the at least one sensor 104A or 104B. In certain embodiments, the alert module 114 can select any number of the one or more hand sanitizing devices 106A-106N, depending on circumstances, and the alert module 114 can send a signal to one or more corresponding or associated tactile alert devices 108A-108N to initiate a respective alert, such as a light, sound, vibration or other tactile output. In this manner, the system 102 can gain the attention of the person 116 as he or she enters or exits a particular area, and direct the person 116 towards a particular hand sanitizing device 106A-106N, thus reminding the person 116 to sanitize his or her hands.

For example, upon detection of entry of a person 116 into a room with two hand sanitizing devices, one hand sanitizing device 106B closer to a patient's bed location than the another hand sanitizing device 106G located on an opposing wall, the alert module 114 can select the hand sanitizing device 106C closer to the patient's bed location. The alert module 114 can transmit a signal to at least one tactile alert device, such as 108B, associated with or adjacent to the selected hand sanitizing device 106B, and the tactile alert device 108B can emit a light to alert the person 116 to wash or sanitize his or her hands using the selected hand sanitizing device 106B.

By way of another example, upon detection of entry of a person 116 into a room with two different types of hand sanitizing devices, such as a hand gel sanitizing device 106B and a hand washing device 106C located within the environment or health care facility 100, the alert module 114 can select one or the other device 106B, 106C depending on a variety of factors, such as a patient's health, the person's prior behavior and/or locations, and/or history of the environment or health care facility. The alert module 114 can transmit a signal or indication to at least one tactile alert device, such as 108C, associated with or adjacent to the selected hand sanitizing device 106C, and the tactile alert device 108C can generate an alert, such as emitting a light and an audible alarm, to alert the person 116 to wash or sanitize his or her hands using the selected hand sanitizing device 106C.

Certain factors may include, but are not limited to, a patient's relative health or health status, a person's activity or behavior with respect to visiting one or more prior locations, a person's compliance record with regard to washing or sanitizing, a person's frequency in washing or sanitizing, a health care facility's prior history in preventing or spreading a particular virus or bacteria, and a health care facility's compliance record with regard to washing or sanitizing.

By way of further example, one or more sensors 104F-104H can be spaced apart within the health care facility 100 when a doorway threshold or wall may not exist between patients or beds. In this example, each of the sensors can include adjustable detection ranges. The detection ranges for each sensor can be programmed such that when a person moving from one patient or bed to another patient or bed may be detected by the one or more sensors 104F-104H. The alert module 104 can, in certain instances, monitor the person's movements, and generate a suitable alert via the tactile alert devices 108A-108N to remind the person to use at least one of the hand sanitizing devices 106A-106N, if the person's movements indicate the person finished working with one patient and has moved his or her attention to begin working with another patient. In these instances, the alert module 114 may initiate an alert from a tactile alert device associated with the hand sanitizing device closest to the person as soon as the person moves away from one patient or sensor and within a predefined range of another patient or sensor.

In certain embodiments, an alert may be delayed for a predefined amount of time. For example, an alert may be delayed for about 10-15 seconds to provide time for a person entering a monitored area, such as 100, to sanitize his or her hands without having to be prompted by the alert or system 102. The alert module 114 can be programmed with suitable computer-executable instructions to define a delay as needed. One will recognize that any predefined amount of time can be used in accordance with embodiments of the disclosure.

After the selected hand sanitizing device, such as 106B, is operated, the alert module 114 can receive an associated signal or indication from the selected hand sanitizing device 106B, and the alert module 114 can cease the alert by the associated tactile alert device 108B. In this instance, the alert, such as the light and audible alarm, can be turned off by the alarm module 114 after the hand sanitizing device 106B is operated.

In certain embodiments, upon detecting the person sanitizing his or her hands before a predefined amount of time, the alert may be undetected by the person. For example, if a predefined amount of time such as about 10-15 seconds elapses and the person entering a monitored area, such as 100, sanitizes his or her hands, the alert may go undetected by the person.

In certain embodiments, the alert by the associated tactile alert device, such as 108B, can be ceased by manual operation of a cutoff or override switch, such as 117A, associated with the tactile alert device 108B with or without operation of a selected hand sanitizing device, such as 106B. In these instances, the alert, such as a light and audible alarm, may be silenced in case of accident or emergency.

By way of another example, a cutoff or override switch, such as 117B, can be a button located adjacent to a patient's bedside, such as a bed/room controller. By way of further example, a cutoff or override switch, such as 117C, can be a sensor located adjacent to or on the patient, which a person or patient may initiate a gesture or verbal command to silence an activated alarm. In any instance, each of the cutoff or override switches 117A-117C can generate a signal, indication, or output for transmission to the alert module 114, which can cease the alert generated by a tactile alert device 108A-108N. In some instances, a cutoff or override switch may directly communicate with a tactile alert device to cease an alert. Any number of cutoff or override switches can be positioned within an environment as needed in accordance with embodiments of the disclosure.

One will recognize that any number of tactile alert devices 108A-108N can be mounted to or integrated in any number of fixtures within or moved within the environment or healthcare facility 100. Further, one will recognize that any number of tactile alert devices 108A-108N can be mounted to or integrated in any number of identification devices present in or otherwise worn by patients or health care personnel in the environment or healthcare facility 100. One may further recognize that any number of corresponding cutoff or override switches or devices may be associated with the tactile alert devices 108A-108N in accordance with embodiments of the disclosure.

In one embodiment, an alert generated by the alert module 114 can be transmitted to a processor-based device, such as 118, associated with a person, such as 116. The alert may be received by the processor-based device 118, and the alert can be silenced or ceased by the person 116 through a command input, such as manual input, by the person 116 to the processor-based device 118. The processor-based device 118 can be a mobile phone, a smartphone, a tablet, a wearable computer, a laptop, a mobile computer, a messaging device, or any other device operable to communicate via a network. In some embodiments, a command input to the processor-based device 118 can be a voice input or a gesture input.

In many instances, operation of at least one hand sanitizing device 106A-106N, after an alarm has been initiated, will be the path of least resistance for ceasing or silencing the alarm.

In the embodiment shown in FIG. 1, the system 102 can include a server and/or host computer 120, which hosts the alert module 114. The server and/or host computer 120 may be a computing device, such as a personal computer (PC), handheld or tablet computer, or other processor-based device. The server and/or host computer 120 can include the memory 112, the one or more processors 110, and one or more communication interfaces or connections 122. Further, the memory 112 can include one or more modules, such as the alert module 114, an operating system 124, one or more counters 126, and any number of other modules with computer-executable instructions.

The alert module 114 of FIG. 1 can also initiate and monitor any number of counters 126, which can track the number of times any number of persons wash or sanitize their hands or otherwise use the hand sanitizing devices 106A-106N. The data accumulated by or otherwise obtained by counters 126 can be combined with times and dates, events, and other environment-related data, and reporting of some or all of the data can be managed by the alert module 114. For example, a report showing the number of dates and times a particular health care worker sanitizes his or her hands after entering a monitored environment, such as 102, can be generated by the alert module 114 to compare with and monitor compliance with any number of applicable health care and facility standards or guidelines.

The alert module 114 of FIG. 1 can also initiate and monitor any number of timers 127, which can track the time a particular person washes or sanitizes their hands, or otherwise uses the hand sanitizing devices 106A-106N. The data accumulated by or otherwise obtained by timers 127 can be compared to by the alert module 114 to any suitable or applicable standard or recommendation for washing and/or sanitizing. For example, a standard, guideline, recommended time, or recommended amount of sanitizer for washing a person's hands can be compared against a person's time or amount of sanitizer to wash his or her hands at a particular hand sanitizing device 106A-106N. In some embodiments, a predefined quantity or amount of sanitizer can be known to be dispensed from a hand sanitizing device over a certain amount of time, thus based on an amount of time the hand sanitizing device is used, the total dispensed quantity or amount of sanitizer can be calculated. In certain instances, the alert module 114 can transmit a suitable signal to a tactile alert device, such as 108A-108N, associated with the particular hand sanitizing device 106A-106N if the standard, guideline, recommended time, or recommended amount of sanitizer is or is not met. In any instance, the alert module 114 can track and monitor compliance with any number of applicable health care and facility standards or guidelines.

Optionally, the server and/or host computer 120 may include removable storage, non-removable storage, one or more input/output interfaces 128, one or more input device(s), and one or more output device(s). The one or more input devices can include, but are not limited to, a keyboard, mouse, pen, voice input device, touch input device, etc., and the one or more output devices can include, but are not limited to, a display, speakers, printer, etc.

In the embodiment shown in FIG. 1, the one or more processors 110 shown can be in communication with the memory 112. The one or more processors 110 can receive signals, indications, or output from the sensors 104A-104N and can process or otherwise store the signals, indications, and outputs in memory 112. The one or more processors 110 may be implemented as appropriate in hardware, software, firmware, or combinations thereof. Software or firmware implementations of the one or more processors 110 may include computer-executable or machine-executable instructions written in any suitable programming language to perform the various functions described. The memory 112 may store program instructions that are loadable and executable on the processor 110 as well as data generated during the execution of these programs. Depending on the configuration and type of environment or system 102, memory 112 may be volatile (such as random access memory (RAM)) and/or non-volatile (such as read-only memory (ROM), flash memory, etc.). The system 102 may include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 112 may include multiple different types of memory, such as static random access memory (SRAM), dynamic random access memory (DRAM), or ROM.

Memory 112, removable storage, and non-removable storage are all examples of computer-readable storage media. For example, computer-readable storage media may include volatile and non-volatile, removable and non-removable media implemented in any method or technology for storage of information such as computer-readable instructions, data structures, program modules or other data. Memory 112, removable storage, and non-removable storage are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can accessed by the server or other computing device. Combinations of any of the above should also be included within the scope of computer-readable media.

However, in other embodiments, computer-readable communication media may include computer-readable instructions, program modules, or other data transmitted within a data signal, such as a carrier wave, or other transmission. However, as used herein, computer-readable storage media does not include computer-readable communication media.

The communication connection or interface 128 may allow one or more of the sensors 104A-104N, hand sanitizing devices 106A-106N, and tactile alert devices 108A-108N to communicate via one or more networks 130 with a server and/or host computer 120. In some examples, the one or more networks 130 may include any one or a combination of multiple different types of networks, such as cable networks, the Internet, wireless networks, cellular networks, and other private and/or public networks. The one or more networks 128 may comprise one or more private networks, public networks such as the Internet, or a combination of both configured to transfer data between two or more devices.

While the embodiment shown in FIG. 1 describes a server and/or host computer 120 with at least one program module, such as alert module 114, one will recognize that certain functionality associated with the server and/or host computer 120 can be distributed to any number and combination of servers, or processor-based devices in accordance with other embodiments of the disclosure.

Various instructions, methods, and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example system 102 shown in FIG. 1 is provided by way of example only. Numerous other apparatus, utility meters, systems, operating environments, system architectures, and device configurations are possible. Accordingly, embodiments of the disclosure should not be construed as being limited to any particular apparatus, utility meter, system, operating environment, system architecture, or device configuration. While the embodiments of the disclosure shown in FIG. 1 are tailored for a health care environment and facility, one will recognize the applicability of other embodiments of the disclosure to other types of facilities and services where sanitizing a person's hands and/or body may be needed.

FIG. 2 illustrates a section view of an example hand sanitizing apparatus according to an embodiment of the disclosure. The hand sanitizing apparatus 200 of FIG. 2 can operate in the environment, a health care facility 100, shown in FIG. 1, and can include similar functionality as the hand sanitizing devices 106A-106N also shown in FIG. 1. The apparatus 200 shown in FIG. 2 can include a housing 202, a sanitizer reservoir 204, a sanitizer dispenser mechanism 206, and a sanitizer output mechanism 208, some or all of which can operate similar to comparable components in conventional hand sanitizing devices. The apparatus 200 can further include one or more tactile alert devices 210A-210N, an operation sensor 212, a cutoff switch 214 and associated input button 216, a communication interface 218, and an optional power supply 220. In some embodiments, the apparatus 200 can include an external light 222, sound output device 224, and/or a vibration generator 226.

The apparatus 200 of FIG. 1 can be mounted to a wall or other fixture near or within an environment, such as a health care facility similar to 100 in FIG. 1. The apparatus 200 can be configured to be operable with and communicate with an alert module of a hand washing and sanitizing alert system, similar to alert module 114 and system 102 in FIG. 1. In one embodiment, a modular-type alert adapter device 228 can include certain components, such as 210A-210N, 212, 214, 216, 218, 220, 222, 224, 226, can be mounted within or to a housing of a conventional hand sanitizer dispenser, and can be integrated with components of an existing conventional hand sanitizer dispenser. In any instance, the apparatus 200 can facilitate providing active and/or passive alerts that may require active hand cleansing and/or washing in order to silence the alerts.

The tactile alert devices 210A-210N of FIG. 2 can be similar to the tactile alert devices 108A-108N described above in FIG. 1. In the embodiment shown in FIG. 2, one tactile alert device 210A can include a light 222 mounted to an external surface of the housing 202 or apparatus 200. Another tactile alert device 210B can include a sound output device 224 mounted to an external surface of the housing 202 or apparatus 200. Yet another tactile alert device 210N can include a vibration generator 226 mounted to an external surface of the housing 202 or apparatus 200. Each of the tactile alert devices 210A-210N can be operable to communicate via the communication interface 218 with the alert module 114 and/or processor 100 of the system 102 shown in FIG. 1. Generally, each the tactile alert devices 210A-210N can be activated when needed, such as when a person enters or exits an environment, for instance, a health care facility 100. In such instances, one or more tactile alert devices 210A-210N can receive a signal, indication, or output from the communication interface 218, which may be in communication with the alert module 114 and/or processor 110 via at least one network 130. Further, an alert from any of the tactile alert devices 210A-210N can be ceased when needed, such as when a person operates the associated apparatus 200, or operates the associated apparatus 200 for a suitable time or obtains a suitable amount of sanitizer from the apparatus 200. In such instances, one or more tactile alert devices 210A-210N can receive a signal, indication, or output from the communication interface 218 and/or cutoff switch 214, either or both of which may be in communication with the alert module 114 and/or processor 110 via at least one network 130. One will recognize that any number of tactile alert devices can be used with the apparatus 200 of FIG. 2 in accordance with embodiments of the disclosure.

The operation sensor 212 of FIG. 2 can be sensor operable to detect dispensing of sanitizer from the sanitizer reservoir 204 and/or sanitizer output mechanism 208, or manipulation of the sanitizer dispenser mechanism 206. When the operation sensor 212 detects dispensing of sanitizer and/or operation, the sensor 212 can generate a signal, indication, or output, which can be transmitted to either or both the communication interface 218 and cutoff switch 214 for processing. In certain embodiments, an operation sensor 212 can be a motion detection device, motion sensor, face detector, identification device reader, and/or thermal sensor. In certain embodiments, the operation sensor 212 may detect the presence of a person, such as a person's hands, adjacent to the apparatus 200, such as immediately below the apparatus 200, which may be indicative of operation of the apparatus 200. One will recognize that any number of operation sensors can be used with the apparatus 200 of FIG. 2 in accordance with embodiments of the disclosure.

The cutoff switch 214 and associated input button 216 of FIG. 2 can be similar to the cutoff switch 117A shown in FIG. 1. When the input button 216, positioned on an external surface of the housing 202, is depressed, the cutoff switch 214 can generate a signal, indication, or output, which can be transmitted to the communication interface 218, or directly transmitted to at least one tactile alert device 210A-210N. In any instance, the signal, indication, or output from the cutoff switch 214 can cease an alert generated by at least one tactile alert device 210A-210N. One will recognize that any number of cutoff switches can be used with the apparatus 200 of FIG. 2 in accordance with embodiments of the disclosure.

The communication interface 218 of FIG. 2 can be a processor or a communications-type device operable to communicate with an alert module or processor associated with a server and/or host computer, such as alert module 114 and processor 110 of server and/or host computer 120 shown in FIG. 1. In the embodiment of FIG. 2, the communication interface 218 can be operable to receive one or more signals, indications, or output from the operation sensor 212, cutoff switch 214, alert module 114 and/or processor 110. Ultimately, the communication interface 218 can transmit one or more signals, indications, or outputs to the tactile alert devices 210A-210N, alert module 114 and/or processor 100 as needed. In certain embodiments, the communication interface 218 can communicate via one or more networks, such as a 130 shown in FIG. 1, with the alert module 114 and/or processor 110.

The optional power supply 220 of FIG. 2 can be a conventional battery or other power generating source, which may provide power to any number of components of the apparatus 200, such as the communication interface 218, the one or more tactile alert devices 210A-210N, and operation sensor 212.

Thus, in operation, the apparatus 200 may be utilized sanitize a person's hands similar to a conventional hand sanitizing device. When a person enters or exits a monitored environment, such as health care facility 100, the person's presence can be detected by the alert module 114, and the alert module 114 can activate one or more tactile devices 210A-210N associated with the apparatus 200 by transmitting a signal, indication, or output to the communication interface 218. The one or more tactile alert devices 210A-210N can generate a corresponding alert, such as emitting light from external light 222, generating a sound from sound output device 224, and/or generating a vibration with vibration generator 226. When the person operates the apparatus 200, such as by dispensing sanitizer or otherwise moving his or her hands adjacent to the apparatus 200, the operation sensor 212 can detect operation of the apparatus 200 or the person's presence adjacent to the apparatus 200. In some embodiments, the operation sensor 212 can detect operation of the associated apparatus 200 for a suitable time or when a suitable amount of sanitizer is obtained from the apparatus 200. In any instance, the operation sensor 212 can transmit a signal, indication, or output to the communication interface 218 and/or cutoff switch 214. In some instances, the cutoff switch 214 can be manually operated to cease the alert from the one or more tactile alert devices 210A-210N. In any instance, the communication interface 218 and/or cutoff switch 214 can transmit a signal, indication, or output to the one or more tactile alert devices 210A-210N to cease the alert. As needed, the communication interface 218 can transmit a signal, indication, or output to the alert module 114 and/or processor 110 to correspond with the status of the one or more tactile alert devices 210A-210N, i.e., generating an alert and/or ceasing an alert.

The example apparatus 200 shown in FIG. 2 is provided by way of example only. Numerous other component, device, and apparatus configurations are possible. Accordingly, embodiments of the disclosure should not be construed as being limited to any particular component, device, and apparatus configuration. While the embodiments of the disclosure shown in FIG. 2 are tailored for a hand sanitizing device, one will recognize the applicability of other embodiments of the disclosure to other types of hand sanitizing devices for sanitizing a person's hands and/or body.

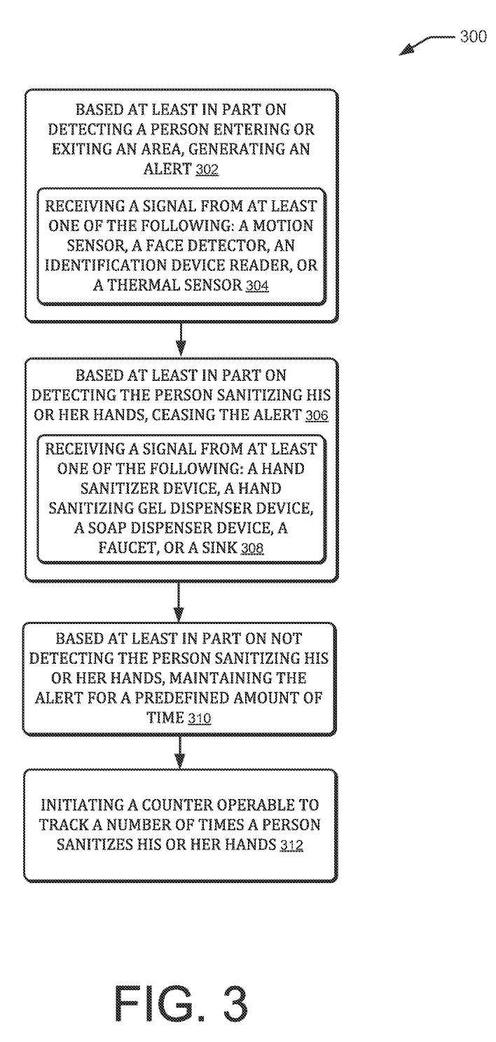

FIG. 3 illustrates an example method according to an embodiment of the disclosure. In the embodiment of FIG. 3, a method for providing hand washing and sanitizing alerts can be provided.

In this particular implementation, the method 300 may begin at block 302 in which based at least in part on detecting a person entering or exiting an area, an alert can be generated.

In at least one embodiment, the alert can be delayed for a predefined amount of time.

The operation of block 302 can, in some embodiments, include the operation of block 304, in which a signal is received from at least one of the following: a motion sensor, a face detector, an identification device reader, or a thermal sensor.

Block 304 is followed by block 306, in which based at least in part on detecting the person sanitizing his or her hands, the alert is ceased.

In at least one embodiment, upon detecting the person sanitizing his or her hands before a predefined amount of time, the alert can be undetected by the person.

The operation of block 304 can, in some embodiments, include the operation of block 308, in which a signal is received from at least one of the following: a hand sanitizer device, a soap dispenser device, a faucet, or a sink.

In at least one embodiment, the area can include at least one of the following: a room, an operating room, a patient room, a laboratory, a kitchen, a testing room, or a building.

In at least one embodiment, the alert can include at least one of the following: an audible sound, a light, a visual cue, or a tactile cue.

Block 308 is followed by block 310, in which based at least in part on not detecting the person sanitizing his or her hands, the alert is maintained for a predefined amount of time.

Block 310 is followed by block 312, in which a counter can be initiated to track a number of times a person sanitizes his or her hands or a timer can be initiated to track a time a person sanitizes his or her hands.

The example environment 100 and system 102 of FIG. 1, and example apparatus 200 of FIG. 2 may perform any, some, or all of the operations of method 300 shown in FIG. 3. The above method 300 is illustrated as a logical flow diagram, in which each operation represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

Illustrative systems, methods, and apparatus for providing hand washing and sanitizing alerts are described above. Some or all of these systems, methods, and apparatus may, but need not, be implemented at least partially by an architecture such as those shown in FIGS. 1-3. It should be understood that certain acts in the methods need not be performed in the order described, may be rearranged or modified, and/or may be omitted entirely, depending on the circumstances. Also, any of the acts described above with respect to any method may be implemented by any number of processors or other computing devices based on instructions stored on one or more computer-readable storage media.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

The claimed invention can include:

1. A method comprising:
based at least in part on detecting a person entering or exiting an area, generating an alert; and
based at least in part on detecting the person sanitizing his or her hands, ceasing the alert.

2. The method of claim 1, wherein the detecting a person entering or exiting an area comprises receiving a signal from at least one of the following: a motion sensor, a face detector, an identification device reader, or a thermal sensor.

3. The method of claim 1, wherein the detecting the person sanitizing his or her hands comprises receiving a signal from at least one of the following: a hand sanitizer device, a hand sanitizing gel dispenser device, a soap dispenser device, a faucet, or a sink.

4. The method of claim 1, wherein the area comprises at least one of the following: a room, an operating room, a patient room, a laboratory, a kitchen, a testing room, or a building.

5. The method of claim 1, wherein the alert comprises at least one of the following: an audible sound, a light, a visual cue, or a tactile cue.

6. The method of claim 1, wherein generating the alert further comprises delaying the alert for a predefined amount of time.

7. The method of claim 6, wherein upon detecting the person sanitizing his or her hands before the predefined amount of time, the alert is undetected by the person.

8. The method of claim 1, further comprising:
based at least in part on not detecting the person sanitizing his or her hands, maintaining the alert for a predefined amount of time.

9. The method of claim 1, further comprising:
initiating a counter operable to track a number of times any person sanitizes his or her hands, or initiating a timer operable to track a time any person sanitizes his or her hands.

10. A system comprising:
at least one sanitizer device;
at least one sensor;
at least one alert device; and
at least one processor operable to execute computer-executable instructions stored in a memory device, the instructions operable to:
based at least in part on detecting, via the at least one sensor, a person entering or exiting an area, generate an alert; and
based at least in part on detecting, via the at least one sanitizer device, the person sanitizing his or her hands, cease the alert.

11. The system of claim 10, wherein the at least one sensor comprises at least one of the following: a motion sensor, a face detector, an identification device reader, or a thermal sensor.

12. The system of claim 10, wherein the at least one sanitizer device comprises at least one of the following: a hand sanitizer device, a soap dispenser device, a faucet, or a sink.

13. The system of claim 10, wherein the area comprises at least one of the following: a room, an operating room, a patient room, a laboratory, a kitchen, a testing room, or a building.

14. The system of claim 10, wherein the alert comprises at least one of the following: an audible sound, a light, a visual cue, or a tactile cue.

15. The system of claim 10, wherein the instructions operable to generate the alert further comprise instructions operable to delay the alert for a predefined amount of time.

16. The system of claim 15, wherein the instructions are further operable to detect the person sanitizing his or her hands within the predefined amount of time, and cease the alert before the alert is detected by the person.

17. The system of claim 10, wherein the instructions further comprise:
based at least in part on not detecting the person sanitizing his or her hands, maintain the alert for a predefined amount of time.

18. The system of claim 10, wherein the instructions further comprise:
initiate a counter operable to track a number of times any person sanitizes his or her hands, or initiate a timer operable to track a time any person sanitizes his or her hands.

19. One or more computer readable media comprising computer-executable instructions stored in a memory for execution by at least one processor, the instructions operable to:
based at least in part on detecting, via at least one sensor, a person entering or exiting an area, generate an alert;
based at least in part on detecting, via at least one sanitizer device, the person sanitizing his or her hands, cease the alert.

20. The one or more computer readable media further comprising instructions operable to:
delay the alert for a predefined amount of time; and
based at least in part on detecting, via the at least one sanitizer device, the person sanitizing his or her hands within the predefined amount of time, cease the alert before the alert is detected by the person.
